(19) United States
(12) Patent Application Publication
(10) Pub. No.: US 2026/0097396 A1
(43) Pub. Date: Apr. 9, 2026

(54) COATED MEMBRANE FOR MEMBRANE ELECTRODE ASSEMBLY FOR ANION EXCHANGE MEMBRANE WATER ELECTROLYSIS AND METHODS OF MAKING SUCH

(71) Applicant: HYDROYAL AB, Solna (SE)

(72) Inventors: Burak KOYUTÜRK, Solna (SE); Göran LINDBERGH, Vallentuna (SE); Ann CORNELL, Lidingö (SE); Matteo ROSSINI, Johanneshov (SE)

(21) Appl. No.: 19/113,582

(22) PCT Filed: Aug. 5, 2023
(86) PCT No.: PCT/SE2023/050781

§ 371 Date: Mar. 20, 2025

(30) Foreign Application Priority Data
Sep. 21, 2022 (SE) 2251092-9

(51) Int. Cl. B01J 47/12; B01J 41/10; B01J 41/12; C25B 1/04; C25B 13/05; C25B 13/08

(52) U.S. Cl. CPC B01J 47/12; B01J 41/10; B01J 41/12; C25B 1/04; C25B 13/05; C25B 13/08

(57) ABSTRACT

A process for producing a coated membrane for an anionic exchange membrane electrode assembly includes mixing a PGM-free catalyst, an ionomer, and an anhydrous solvent forming a solution, coating a non-fluorinated substrate with the solution forming a coated substrate and drying the coated substrate allowing the anhydrous solvent to evaporate forming a dried coated substrate. The dried coated non-fluorinated substrate is applied to a surface of a hydroxyl-free anion-exchange membrane including non-hydroxyl ions forming a membrane substrate assembly that is pressed using a hot-press. The substrate is removed from the pressed membrane substrate assembly forming a coated membrane. The non-hydroxyl ions in the anionic exchange membrane are replaced by hydroxyl ions by soaking the coated membrane in a hydroxyl ion solution.

### FIELD OF INVENTION

The present invention relates to a manufacturing process for formation of an anion exchange membrane electrode assembly.

### BACKGROUND

Hydrogen production from water electrolysers is considered a promising approach for carbon-neutrality. PEMWEs offer fast kinetics and high efficiency due to well-developed proton exchange membranes and PGMs employed in both anode and cathode. However, the use of PGMs as catalysts negatively affect the cost of the cells. Additionally, PGMs are not available in such large quantities as required for the calculated need for hydrogen production from water electrolysers. Recent development of AEMWEs with PGM-free catalysts have showed high potential for a low cost. The problem with PGM-free AEMWEs is their production. The current processes for production are not scalable and thus does not allow for large scale production of AEMWEs.

EP 3 923 389 A1 discloses a method of preparing a composite ion-exchange membrane supported with a porous polymer material, a composite ion-exchange membrane prepared by the method, and a use thereof.

In the prior art there is a need for improved processes of anion exchange membranes that are suitable for large scale production.

### SUMMARY

The present invention aims to solve the problems of the prior art. This is achieved by the process and membrane according to the independent claims.

In a first aspect of the invention there is a process for producing a coated membrane for an anionic exchange membrane electrode assembly. The process comprises the steps of:
mixing a platinum group metal (PGM) free catalyst, an ionomer, and a solvent forming a solution;
coating a first non-fluorinated substrate with the solution formed in the mixing step forming a first coated non-fluorinated substrate;
drying the first coated non-fluorinated substrate allowing the solvent to evaporate forming a first dried coated non-fluorinated substrate;
applying the first dried coated non-fluorinated substrate to a first surface of a hydroxyl-free anion-exchange membrane forming a membrane substrate assembly, wherein the hydroxyl-free anion-exchange membrane comprises non-hydroxyl ions;
pressing the membrane substrate assembly using a hot-press forming a pressed membrane substrate assembly;
removing the first non-fluorinated substrate from the pressed membrane substrate assembly forming a coated membrane; and
exchanging the non-hydroxyl ions in the hydroxyl-free anionic exchange membrane for hydroxyl ions by soaking the coated membrane in a hydroxyl ion solution.

In an embodiment, the first non-fluorinated substrate is selected from the group consisting of a PET substrate and a PI substrate, preferably a PET substrate.

In an embodiment, coating the first non-fluorinated substrate further comprises coating a second non-fluorinated substrate with the solution formed in the mixing step forming a second coated non-fluorinated substrate. Drying the first coated non-fluorinated substrate further comprise drying the second coated non-fluorinated substrate allowing the solvent to evaporate forming a second dried coated non-fluorinated substrate. Applying the first dried coated non-fluorinated substrate further comprises applying the second coated non-fluorinated substrate to a second surface of the hydroxyl-free anion-exchange membrane. The second surface of the hydroxyl-free anion-exchange membrane is opposite to the first surface.

In an embodiment, pressing the membrane substrate assembly comprises hot pressing the membrane substrate assembly using the hot-press when the first dried coated non-fluorinated substrate has been applied to the first surface and the second dried non-fluorinated substrate has been applied to the second surface of the hydroxyl-free anion-exchange membrane.

In an embodiment, the first and second non-fluorinated substrates are each selected from the group consisting of a PET substrate and a PI substrate, preferably the first and second non-fluorinated substrates are PET substrates.

In an embodiment, the solvent is an anhydrous solvent.

In an embodiment, the solvent is selected from the group consisting of NMP, DMF, DMSO and a mixture thereof, preferably DMSO.

In an embodiment, coating the first non-fluorinated substrate comprises coating the first non-fluorinated substrate with the solution using a decal method forming the first coated non-fluorinated substrate.

In an embodiment, the PGM-free catalyst is selected from the group consisting of Ni, Fe, Co, Al, Cr, Mo, Ti, Cu, and any combination thereof, preferably selected from the group consisting of NiFe and Ni/Al.

In an embodiment, the platinum group metal free catalyst comprises PGM-free catalyst particles. In a particular embodiment, the PGM-free catalyst particles have an average diameter selected within a range of from 40 nm to 60 μm.

In an embodiment, the ionomer is selected from the group consisting of a cation exchange ionomer and an anion exchange ionomer, preferably selected from the group consisting of a hexamethyl-p-terphenyl poly(benzimidazolium) and a sulfonated tetrafluoroethylene based fluoropolymer-copolymer.

In an embodiment, the coated membrane comprises from 2 up to 20 mg, such as from 4 up to 20 mg, PGM-free catalyst per cm² on the first surface of the hydroxyl-free anion-exchange membrane.

In an embodiment, at least 25 cm², preferably at least 30 cm², more preferably at least 50 cm², most preferably at least 75 cm², such as at least 100 cm², of the first surface of the hydroxyl-free anion-exchange membrane comprises a coating comprising the PGM-free catalyst and the ionomer.

In a second aspect of the invention there is an anionic exchange membrane electrode assembly comprising two electrodes and a coated membrane obtainable by the process according to the invention sandwiched between the two electrodes.

In an embodiment, the coated comprises a catalyst-comprising coating comprising PGM-free catalyst particles. In a particular embodiment, the PGM-free catalyst particles have an average diameter selected within a range of from 20 nm to 50 μm.

In a third aspect of the invention there is a coated membrane for water electrolysis obtainable by the process according to the invention.

In an embodiment, the coated comprises a catalyst-comprising coating comprising PGM-free catalyst particles. In a particular embodiment, the PGM-free catalyst particles have an average diameter selected within a range of from 50 nm to 50 μm.

In a fourth aspect of the invention there is a water electrolysis cell comprising a coated membrane according to above.

### BRIEF DESCRIPTION OF THE DRAWINGS

The embodiments, together with further objects and advantages thereof, may best be understood by making reference to the following description taken together with the accompanying drawings, in which:

FIG. 1. Schematic illustrations of (A-F) production of a coated membrane according to an embodiment, (G) a membrane substrate assembly according to an embodiment and (H) a coated membrane according to an embodiment of the invention.

FIG. 2. A flow-chart of an embodiment according to the invention.

FIG. 3. A flow-chart of another embodiment according to the invention.

FIG. 4. A graph of a polarization curve of an example according to the invention.

FIG. 5. A graph of a polarization curve of an example according to the invention and one comparative example.

FIG. 6. A graph from a stability test from an example according to the invention.

FIG. 7. Polarization curves of AEMWE system using MEAs with 5 wt %, 10 wt % and 15 wt % ionomer content on the anode side. Nickel felt was used as the cathode and 1 M KOH was used as the electrolyte. All experiments were performed at 60° C.

FIG. 8. SEM micrographs of anode CLs with 5 wt % (A), 10 wt % (B), 15 wt % (C) ionomer content. Morphology of CL with 5 wt % ionomer (D).

FIG. 9. Polarization curve with MEAs with 10 wt %, 15 wt % and 20 wt % ionomer content in the cathode CL. 5 wt % ionomer CL was used at anode. 1 M KOH 60° C.

FIG. 10. SEM micrographs of cathode CLs with 10 wt % (A), 15 wt % (B) ionomer content. Morphology of CLs with 10 wt % (C) and 15 wt % ionomer (D).

FIG. 11. Polarization curves with MEAs with 5 wt % high IEC, low IEC, Nafion™ ionomer content 0.20 wt % high IEC ionomer CL is used at cathode. 1 M KOH 60° C. (A). Stability test at 200 mA/cm² (B). Polarization curves after stability test (C).

FIG. 12. SEM cross-sections of an MEA with 20 wt % ionomer in the cathode and 5 wt % ionomer in the anode before (A) and after (B) after 100 h AEMWE test at 200 mA/cm².

FIG. 13. SEM cross-sections of an MEA with 20 wt % ionomer in the cathode and 5 wt % Nafion™ in the anode before (A) and after (B) after 200 h AEMWE test at 200 mA/cm².

FIG. 14. Photographs of coatings on (A, B) PTFE or (C, D) PET substrates prior to (A, C) and after (B, D) drying using propanol as solvent.

FIG. 15. Photographs of coatings on (A, B) PTFE, (C, D) PET or (E, F) FEP substrates prior to (A, C, E) and after (B, D, F) drying using DMSO as solvent.

FIG. 16. Photographs of coating on PET substrates prior to (A, C) and after (B, D) drying using DMSO containing 5 wt % (A, B) or 9 wt % (C, D) water.

FIG. 17. Schematic illustration of a membrane electrode assembly according to an embodiment.

### ABBREVIATIONS

AEM—anion exchange membrane
AEMWE—anion exchange membrane water electrolyser
APS—aerodynamic particle sizer
AWE—alkaline water electrolysis
BET—Brunauer, Emmett and Teller
CCM—catalyst coated membrane
CL—catalyst layer
DMF—dimethylformamide
DMSO—dimethyl sulfoxide
EDS—energy-dispersive X-ray spectroscopy
EIS—electrochemical impedance spectroscopy
FEP—fluorinated ethylene propylene
GDL—gas diffusion layer
HDPE—high density polyethylene
HER—hydrogen evolution reaction
HFR—high frequency resistance
IEC—ion exchange capacity
MEA—membrane electrode assembly
NMP—N-methyl-2-pyrrolidone
OER—oxygen evolution reaction
PEM—proton exchange membrane
PEMWE—proton exchange membrane water electrolyser
PET—polyethylene terephthalate
PGM—platinum group metal
PI—polyimide
PID—proportional integral derivative
PTFE—polytetrafluoroethylene
SEM—scanning electron microscope

### DETAILED DESCRIPTION

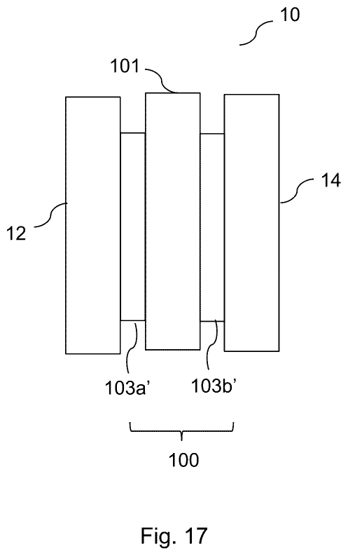

A membrane electrode assembly (MEA) 10, see FIG. 17, comprises an anionic membrane 101 coated on each side with a catalyst-containing coating 103a′, 103b′ to form a coated membrane 100. The coated membrane 100 is placed between two electrodes 12, 14 and, thus, forming a membrane electrode assembly 10. MEAs 10 are used in different applications, such as in fuel cells and electrolysers. For PEMs, efficient and cheap production processes have been developed, such as the use of decal techniques to coat the membrane(s) with catalysts. Decal techniques refer to techniques wherein a catalyst ink is coated on decal substrates, dried and transferred to the membrane. For the AEMs, in particular for electrode preparation for AEMWEs, there exists no such methods. It was recently reported that the decal method that is commonly used for PEM production processes is not suitable for production of AEMs (Miller et al., Sustainable Energy & Fuels 4:2114-2133 (2020). It is, however, desirable to use the decal method to coat an AEM since it allows for large scale production with high control and precise loading.

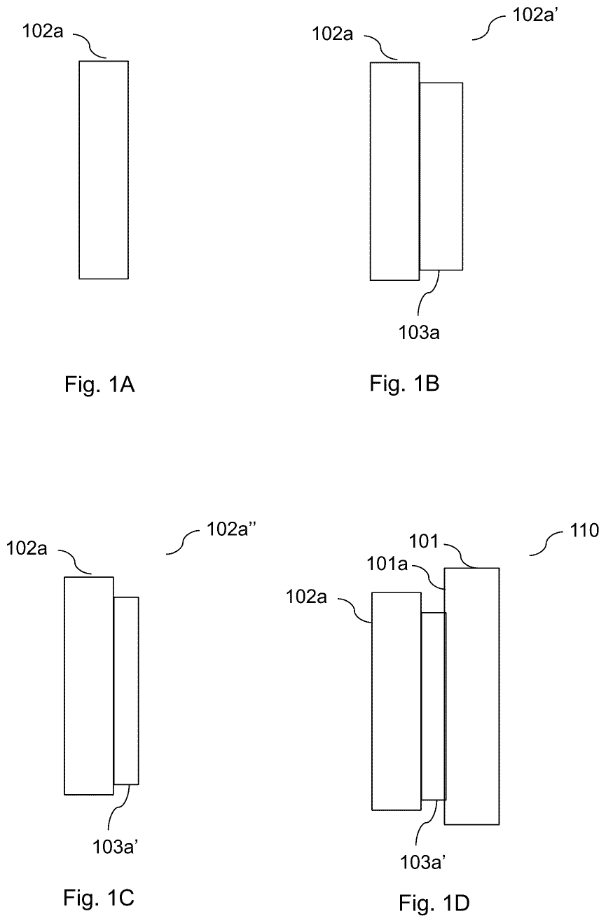

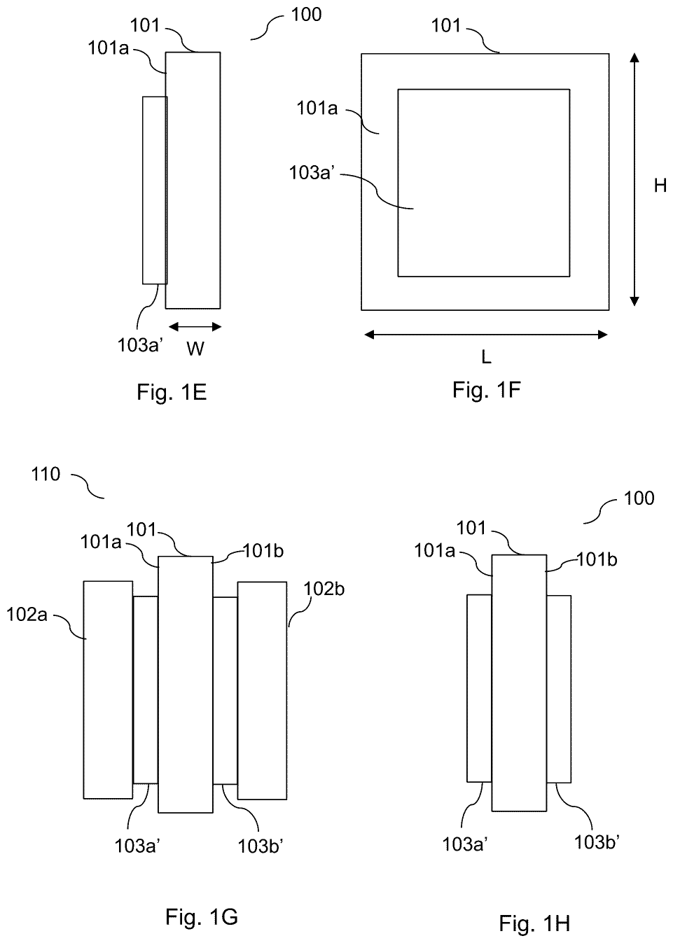

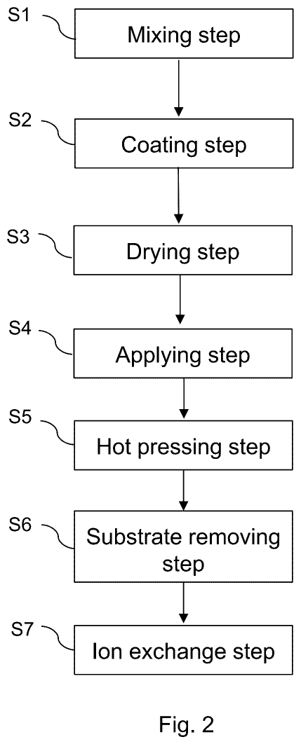

An aspect of the invention relates to a process for producing a coated membrane 100, such as a coated membrane 100 for an anionic exchange membrane electrode assembly 10. A flow-chart of the process is shown in FIG. 2, reference is also made to FIGS. 1A to 1E. The process comprises mixing, in step S1, a PGM-free catalyst, an ionomer, and a solvent forming a solution. The process also comprises coating, in step S1, a first non-fluorinated substrate 102a, see FIGS. 1A and 1B, with the solution formed in the mixing step S1 forming a first non-fluorinated coated substrate 102a′. The process further comprises drying, in step S3, the first coated non-fluorinated substrate 102a′ allowing the solvent to evaporate forming a first dried coated substrate 102a″, see FIG. 1C. The first dried coated non-fluorinated substrate 102a″ is applied in step S4 to a first surface 101a of a hydroxyl-fee anion-exchange membrane 101 forming a membrane substrate assembly 110, see FIG. 1D. The hydroxyl-free anion-exchange membrane 101 comprises non-hydroxyl ions. The process also comprises pressing, in step S5, the membrane substrate assembly 110 using a hot-press forming a pressed membrane substrate assembly. The first non-fluorinated substrate 102a is then removed in step S6 from the pressed membrane substrate assembly forming a coated membrane 100, see FIG. 1E. The process further comprises exchanging, in step S7, the non-hydroxyl ions in the anionic exchange membrane 101 for hydroxyl ions by soaking the coated membrane 100 in a hydroxyl ion solution.

FIG. 1A shows the non-fluorinated substrate 102 prior to coating, whereas FIG. 1B shows the non-fluorinated substrate 102a having one of its surfaces coated with the solution as obtained in step S1 of FIG. 2. At least a portion of the surface of the non-fluorinated substrate 102a thereby comprises a solution coating 103a. FIG. 1C illustrates the dried coated non-fluorinated substrate 102a′ following evaporation of the solvent. Accordingly, at least a portion of the surface of the dried non-fluorinated substrate 102a′ comprises a catalyst coating 103a′, i.e., a coating comprising the catalyst and the ionomer but with at least a majority of the solvent removed during the drying step S2. FIG. 1D illustrates the membrane substrate assembly 110 obtained by applying the dried coated non-fluorinated substrate 102a″ to a surface 101a of the hydroxyl-free anion-exchange membrane 101. This application of the dried coated non-fluorinated substrate 102a″ means that the dried coated non-fluorinated substrate 102a″ is applied to the hydroxyl-free anion-exchange membrane 101 with the catalyst coating 103a′ facing and coming in contact with at least a portion of the surface 101a of the hydroxyl-free anion-exchange membrane 101 as shown in FIG. 1D. The membrane substrate assembly 110 is then hot-pressed in step S5 for a predetermined time period and using a predetermined temperature to form a pressed membrane assembly. Following the hot-pressing in step S5, the non-fluorinated substrate 102a can be removed from the pressed membrane assembly, while leaving at least a major portion of the catalyst coating 103a′ attached to the surface 101a of the hydroxyl-free anionic exchange membrane 101 as shown in FIG. 1E.

The hydroxyl-free anionic exchange membrane 101 used in the process is hydroxyl free, i.e., does not contain any detectable amounts of hydroxyl ions. In clear contrast, the hydroxyl-free anionic exchange membrane 101 comprises non-hydroxyl ions, i.e., ions other than hydroxyl ions. Illustrative, but non-limiting, examples of such non-hydroxyl ions include Br⁻, I⁻ and Cl⁻. The non-hydroxyl ions in the hydroxyl-free anionic exchange membrane 101 are then exchanged in step S6 of FIG. 2 by soaking the coated membrane 100 in a hydroxyl ion solution, i.e., a solution comprising hydroxyl ions. This ion exchange step thereby replaces the non-hydroxyl ions in the hydroxyl-free anionic exchange membrane 101 with hydroxyl ions. This means that the coated membrane 100 as produced in the process comprises an anionic exchange membrane 101 comprising hydroxyl ions and having a catalyst coating 103a′ on at least a portion of at least one surface 101a.

The hot pressing in step S5 is performed for a predetermined time period and using a predetermined temperature to form the pressed membrane substrate assembly. The predetermined time period and temperature can be selected based on the transfer efficiency of catalyst to membrane. Illustrative, but non-limiting, examples of suitable pressing periods include from 100 up to 600 s, such as from 200 up to 400 s, or about 300 s. Illustrative, but non-limiting, examples of suitable pressing temperature include from 100 up to 200° C., such as from 120 up to 180° C., or about 140° C.

The ion exchange step S7 in FIG. 2 is included to replace the counter ions, such as Br⁻, I⁻ and Cl⁻, of the hydroxyl-free anion exchange membrane 101 with hydroxyl ions. The hydroxyl ion solution used in this step S7 and in which the hydroxyl-free anion exchange membrane 101 is soaked could be a NaOH solution, a KOH solution, a mixture thereof, or indeed any hydroxyl ion solution. For instance, the hydroxyl-free anion exchange membrane 101 could be immersed in a 1 M KOH for 36 h, refreshing the solution twice, to replace the counter ions with OH− ions.

The first surface 101a of the hydroxyl-free anionic exchange membrane 101 is a so-called first main surface of the hydroxyl-free anionic exchange membrane 101. Generally, a hydroxyl-free anionic exchange membrane 101 having a rectangular or quadratic shape has a length L, a height H and a width W as shown in FIGS. 1E, 1F. A main surface of the hydroxyl-free anionic exchange membrane 101 is then a surface as defined by the length L and height H as shown in FIG. 1F. A circular hydroxyl-free anionic exchange membrane 101 correspondingly have circular main surfaces.

In the above-described embodiment, the coated membrane 100 comprises a catalyst-containing coating 103a′ on at least a portion of a first surface 101a. It is, however, possible to coat opposite surfaces 101a, 101b of the hydroxyl-free anion-exchange membrane 101 as shown in FIGS. 1G and 1H. In such an embodiment, step S2 in FIG. 2 further comprises coating a second non-fluorinated substrate 102b with the solution (formed in step S1) forming a second non-fluorinated substrate. Step S3 further comprises, in this embodiment, drying the second coated non-fluorinated substrate allowing the solvent to evaporate forming a second dried coated non-fluorinated substrate. In this embodiment, step S4 further comprises applying the second coated non-fluorinated substrate to a second surface 101b of the hydroxyl-free anion-exchange membrane 101. The second surface 101b of the hydroxyl-free anion-exchange membrane 101 is opposite to the first surface 101a.

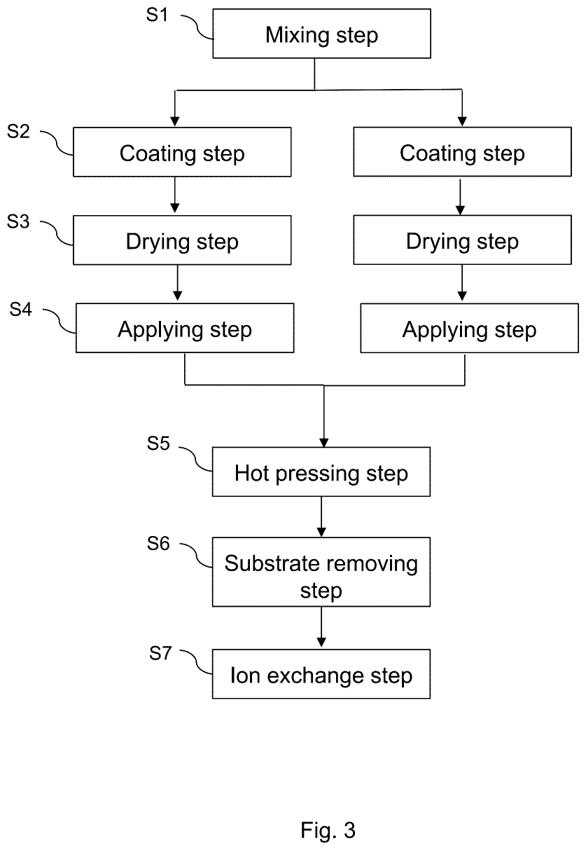

Such a process is schematically illustrated in FIG. 3, i.e., where opposite surfaces 101a; 101b of a hydroxyl-free anion-exchange membrane 101 are coated with catalyst-containing solution in parallel using a decal method.

In an embodiment, step S5 then comprises hot pressing the membrane substrate assembly 110 using the hot-press when the first dried coated non-fluorinated substrate 102a″ has been applied to the first surface 101a and the second dried non-fluorinated substrate has been applied to the second surface 101b of the hydroxyl-free anion-exchange membrane 101.

FIG. 1G is a schematic drawing of a membrane substrate assembly 110 according to one embodiment of the invention where two opposing surfaces 101a, 101b of the hydroxyl-free anion-exchange membrane 101 are coated with a respective catalyst-containing coating 103a; 103b. FIG. 1G shows the membrane substrate assembly 110 with the non-fluorinated substrates 102a; 102b still left, i.e., after the formation of the membrane-substrate assembly 110 in step S4, and FIG. 1H shows an illustration of the resulting coated membrane 101 following removal of the non-fluorinated substrates 102a; 102b, i.e., after the substrate removal step S5.

PGMs include for example Ni, Fe, Co, Al, Cr, Mo, Ti, Cu. PGM catalysts are generally selected from a group consisting of Pt, Ir, Pd, Ru, Os, Rh and mixtures of those. The present invention, though, uses PGM free catalysts to form the solution in step S1 in FIG. 2. It is an advantage with the invention to use PGM free metals as catalysts since such PGM free catalysts are relatively cheap and abundant. In an embodiment, PGM free catalysts include, for example, Ni, Fe, Co, Al, Cr, Mo, Ti, Cu. Hence, in an embodiment, the PGM free catalyst is preferably selected from the group consisting of Ni, Fe, Co, Al, Cr, Mo, Ti, Cu, and any combination or mixture thereof. In a preferred embodiment, the PGM free catalyst is selected from the group consisting of NiFe and Ni/Al.

In an embodiment, the PGM-free catalyst comprises PGM-free catalyst particles. In such an embodiment, the PGM-free catalyst particles preferably have a particle size or diameter within the nm to μm range. For instance, at least a majority of the PGM-free catalyst particles could have a particle size or diameter from about 1 nm up to about 100 μm. In a particular embodiment, the PGM-free catalyst particles have an average diameter selected within a range of from 40 nm to 60 μm.

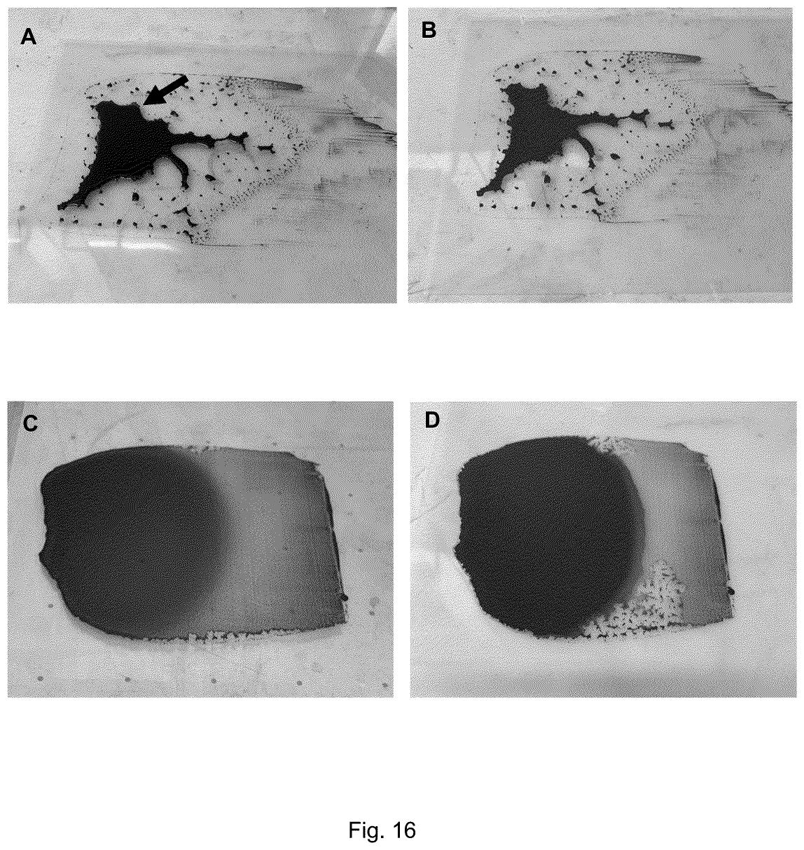

In an embodiment, the solvent is an anhydrous solvent. An anhydrous solvent refers to a solvent that is water-free or essentially water-free. As used herein, an anhydrous solvent may comprise a small amount of water such as 5% (weight percentage) or less of water. As is shown in FIGS. 16A-16D, including up to 5 wt % water in the solvent did not significantly negative affect the coating, whereas a coating with a water content of 9 wt % contracted on the non-fluorinated substrate.

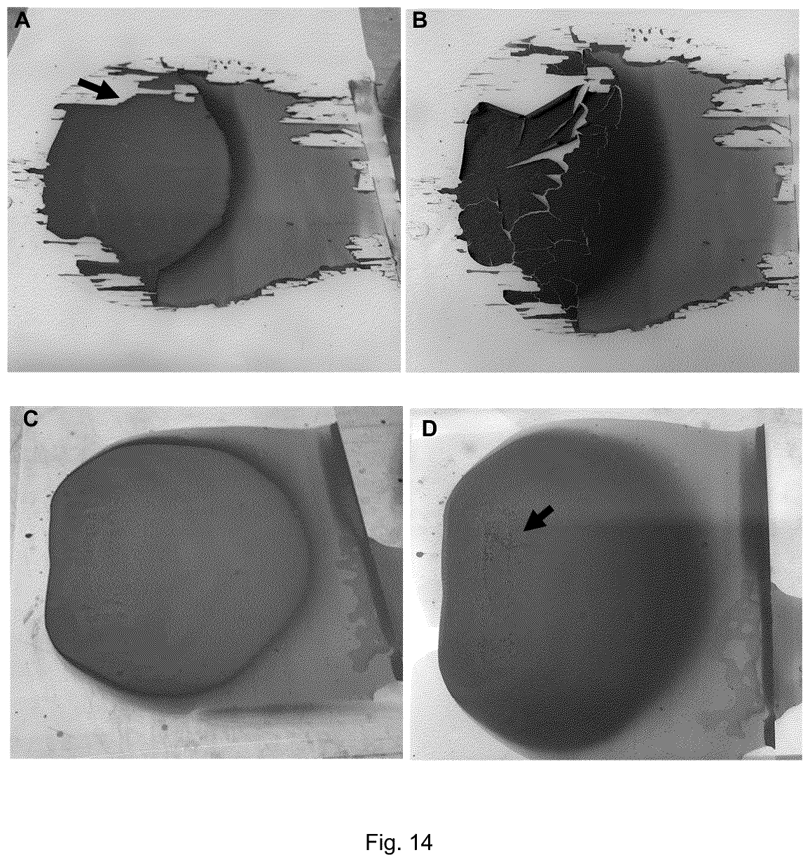

Without being bound by any theory, the use of an anhydrous solvent together with a non-fluorinated substrate and hydroxyl-free ions in the hydroxyl-free anion-exchange membrane 101, which in step S7 are exchanged for hydroxyl ions, may be beneficial in the process. It may help to avoid the formation of cracks in the coated membrane 100 that otherwise may be formed during the process. This is shown in FIGS. 14A-14D showing photographs of coatings on fluorinated substrates in the form of PTFE substrates, see FIGS. 14A and 14B, and coatings on non-fluorinated substrates in the form of PET substrates, see FIGS. 14C and 14D. FIGS. 14A, 14C illustrate the substrates prior to drying in step S3, whereas FIGS. 14B, 14D illustrate the substrate following drying in step S3. As is shown by comparing FIGS. 14A and 14C, the coating has a tendency to contract when coated on the PTFE substrate, whereas no such contraction is seen when coated on the PET substrate. After drying, the coating cracks and peel off on the PTFE substrate as shown in FIG. 14B, whereas the coating remains firmly attached to the PET substrate after coating as shown in FIG. 14D. Hence, the coating cracks on the PTFE substrate and can thereby not be transferred to any hydroxyl-free anionic exchange membrane. Accordingly, fluorinated substrates cannot be used in transferring the coating to the hydroxyl-free anionic exchange membrane.

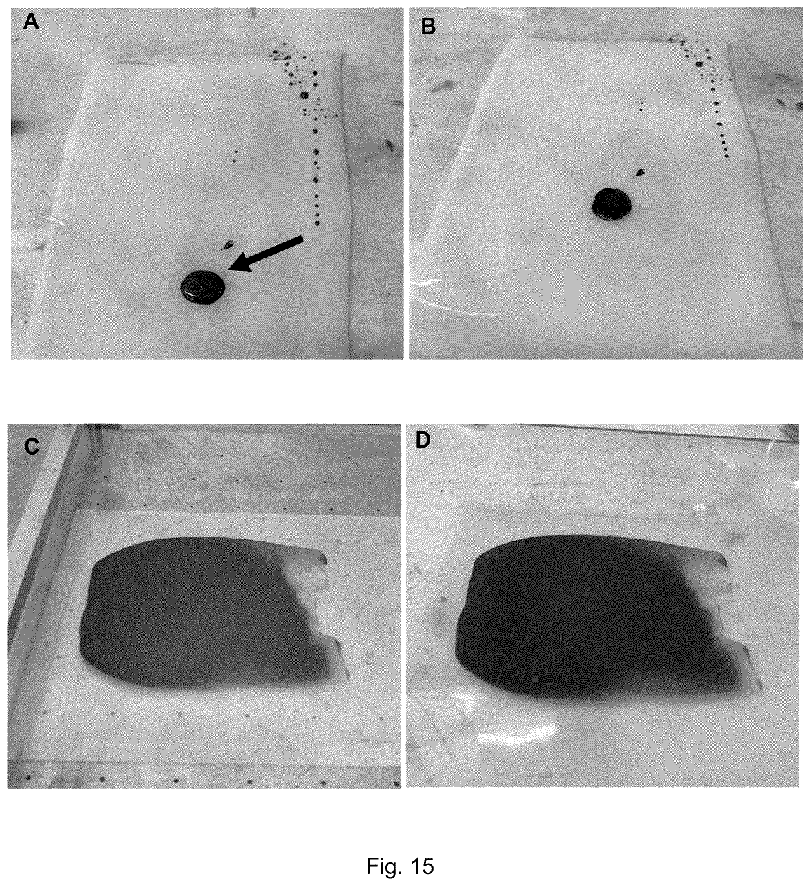

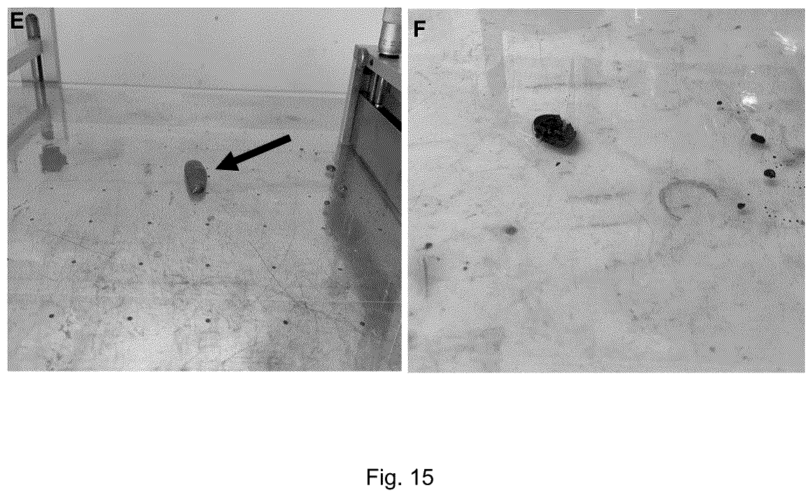

In the FIGS. 14A-14D, the solvent in the solution was propanol. FIGS. 15A-15D illustrate the corresponding results using DMSO as solvent in the solution and in FIGS. 15E-15F using another fluorinated substrate in the form of a FEP substrate. Prior to drying, the coatings on the PTFE and FEP substrates suffers from contraction, see FIGS. 15A, 15E, and suffer from peeling off from the PTFE and FEP substrate following drying, see FIGS. 15B, 15F. The coatings on the PET substrates do not suffer from these problems, see FIGS. 15C, 15D.

In an embodiment, the solvent is selected from the group consisting of DMSO, DMF, NMP, and a mixture thereof. In a preferred embodiment, the solvent is DMSO. The dried coating in FIG. 14D has a non-homogenous portion indicated by the arrow when using propanol as solvent. However, the coating in FIG. 15D obtained using DMSO as solvent had significantly less problems with homogeneity.

The ionomer used in the mixing step S1 functions as a binder. Many types of ionomers may be used in the process according to the invention, for example cation exchange ionomers or anion exchange ionomers. Such ionomers, or binders are well-known to persons skilled in the art. Illustrative, but non-limiting, examples of such ionomers include Nafion™ (a sulfonated tetrafluorethylene based fluorpolymer-copolymer) and Aemion™ (a hexamethyl-p-terphenyl poly(benzimidazolium).

In an embodiment, a decal method is used to coat the first non-fluorinated substrate 102a and preferably also the second non-fluorinated substrate 102b. A decal method refers to a method wherein substrate(s) 102a; 102b are coated with a catalyst-containing solution and dried forming a catalyst-containing coating, also referred herein simply as catalyst coating, 103a. The catalyst-containing coating 103a is later transferred to one or opposite surfaces 101a; 101b of a hydroxyl-free anion-exchange membrane 101. Such methods or processes enables a higher precision of the coating process as compared with processes in the prior art wherein the catalysts ink is manually painted on the membrane(s).

A process according to the invention enables large scale manufacturing of coated anionic-exchange membranes 101 with PGM-free catalysts. Furthermore, the manufacturing process can be controlled so that the catalyst layer or coating is evenly distributed at the surface(s) 101a; 101b of the anionic-exchange membrane 101 with a controlled amount of catalyst(s) at each cm². A controlled manufacturing process that enables a controlled large-scale production may be important for commercial use of PGM-free electrodes with anion exchange membranes 101 in for example water electrolysis or hydrogen production.

A process according to the invention uses one or more non-fluorinated substrates 102a; 102b. As discussed above this may be beneficial in terms of avoiding formation of cracks in the catalyst-containing coatings 103a during the process. In one embodiment of the invention, the non-fluorinated substrate(s) 102a; 102b comprises polyethylene terephthalate (PET) and/or polyimide (Kapton®). Both PET and Kapton® are common materials in different MEA applications and easily accessible. They are additionally well-studied in these types of applications. Hence, in an embodiment, the first non-fluorinated substrate 102a is, or the first and second non-fluorinated substrates 102a, 102b are, selected from the group consisting of a PET substrate and a PI substrate. In the preferred embodiment, the first non-fluorinated substrate 102a is a PET substrate, or the first and second non-fluorinated substrates 102a, 102b are PET substrates.

In an embodiment, the coated membrane 100 comprises from 2 up to 20 mg, such as from 4 up to 20 mg, PGM free catalyst per cm² on the first surface 101a, or on the first and second surfaces 101a, 101b, of the hydroxyl-free anion-exchange membrane 101. For instance, the loading of the PGM free catalyst is 2 mg/cm², 4 mg/cm² or 5 mg/cm², or 10 mg/cm² on one or both surfaces 101a, 101b of the coated membrane 100.

In an embodiment, at least 25 cm², preferably at least 30 cm², more preferably at least 50 cm², and most preferably at least 75 cm², or even more, such as at least 100 cm² or at least 200 cm² or indeed even higher, such as at least 250 cm² or at least 300 cm², of the first surface 101a, or of the first and second surfaces 101a, 101b, of the hydroxyl-free anion-exchange membrane 101 comprises a coating 103a comprising the PGM free catalyst and the ionomer, i.e., the catalyst-containing coating 103a.

The present invention also relates to an anionic exchange membrane electrode assembly 10 as shown in FIG. 17. Such an anionic exchange membrane electrode assembly 10 comprises two electrodes 12, 14 and a coated membrane 100 obtainable by the process of the invention sandwiched between the two electrodes 12, 14.

A coated membrane 100 according to the invention may be used in different applications as part of a MEA, such as for example water electrolysis cells and fuel cells. In one aspect of the invention there is a coated membrane 100 for water electrolysis cell obtainable by the process according to the invention. The invention also relates to a water electrolysis cell comprising such a coated membrane 100. In one embodiment, the coated membrane 100 in the water electrolysis MEA comprises a PGM-free catalyst and is formed using a PET or PI substrate. The loading of the PGM-free catalyst is 2-20 mg/cm² such as 4-20 mg/cm², over an area of at or above 25 cm².

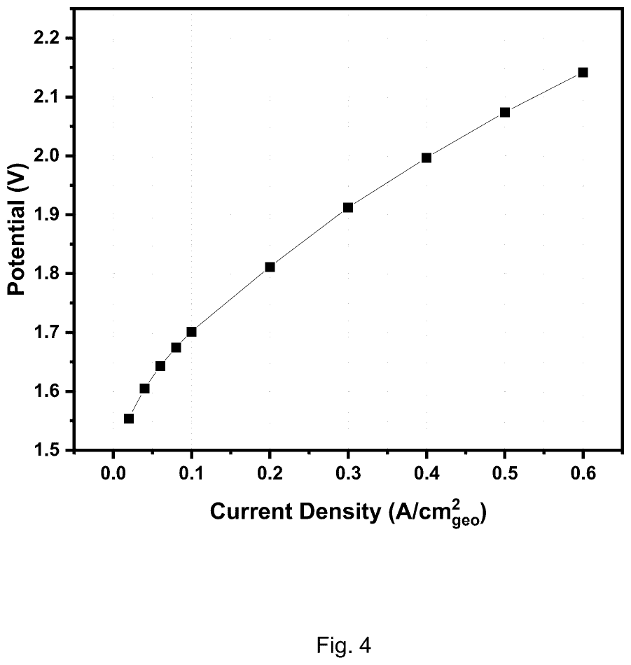

FIG. 4 shows a polarization curve of a MEA comprising a coated membrane 100 according to the invention. The polarization curve is recorded in 5 cm² anion exchange membrane water electrolysis setup at 50° C. with 0.5 M KOH.

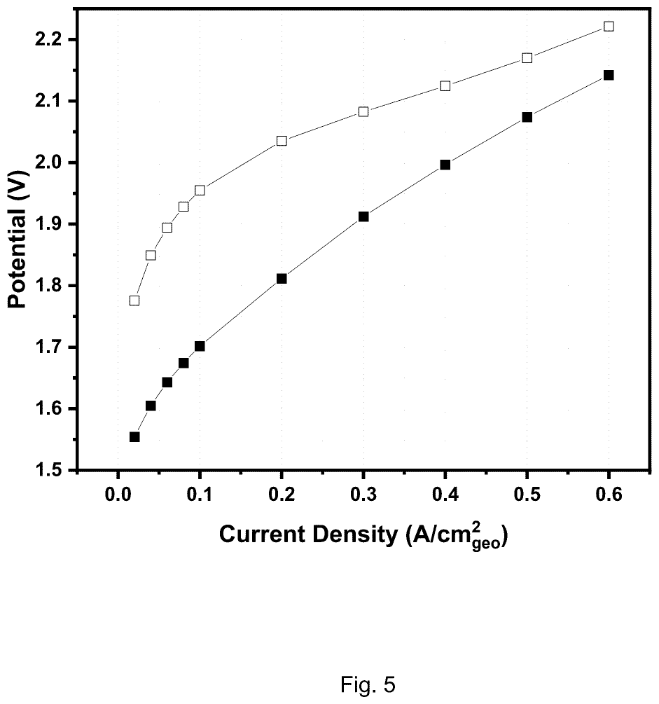

FIG. 5 shows a comparative example wherein a polarization curve for a MEA comprising a coated membrane 100 according to the invention (□) is compared with a polarization curve for a MEA comprising a commercial membrane and Ni felt electrodes (▪). As can be seen in the figure a MEA comprising a coated membrane 100 according to the invention give as better results when compared with a MEA comprising a commercial membrane.

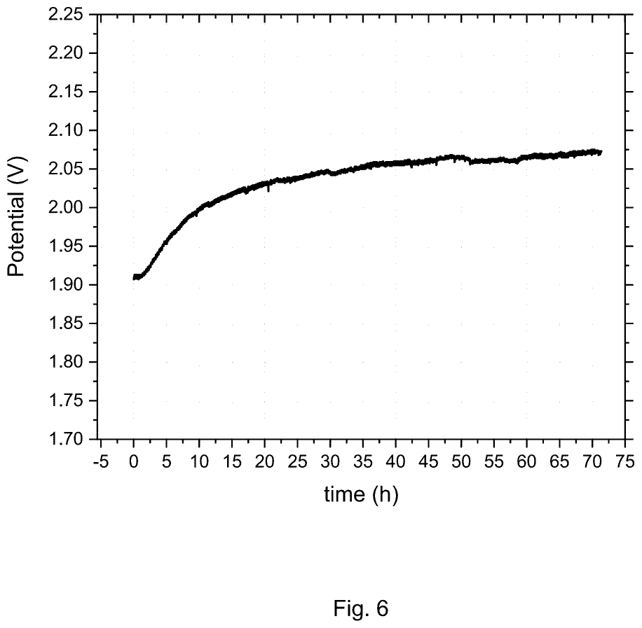

FIG. 6 shows the results from a stability test from a MEA comprising a coated membrane 100 according to the invention. As can be seen the MEA is stable for at least 70 hours. The data was recorded in 5 cm² anion exchange membrane water electrolysis setup at 50° C. with 0.5 M KOH at 0.4 A/cm².

### EXAMPLES

### Example 1

### Membrane Electrode Assembly (MEA) Preparation

MEAs were fabricated with catalyst coated membrane method using a decal transfer technique. Fe—Ni (US Research Nanomaterials, Inc) nanoparticles were used as anode catalysts. Solutions containing the nanoparticles (i.e., ink) were prepared by dispersing the catalyst materials in ionomer solution. The dispersion was mixed overnight in 8 mL HDPE bottle adding ZrO₂ beads with diameter of 5 mm. Ionomer-to-catalyst ratio was kept as 0.1 for all the electrodes. The ink was coated on 75 μm thick and temperature resistant substrate (PET) with doctor blade and the coating was punched with 5 cm² cutting die. The cathode was prepared with Raney Ni catalyst and AP1-HNN8-00-X ionomer (IONOMR™) and coating on PET. The substrates with coatings and the membranes (FAA-3-50) were aligned and hot-pressed at 140° C. for 5 min. The substrates were peeled off after the hot-press and the precise loadings were determined by subtracting the weight of the substrate from the weight of sum of the substrate and the electrode before hot-press. 3 mg/cm² loading was used in anode for each measurement. MEAs were kept in 1 M KOH for at least 36 h exchanging the KOH solution for 3 times for proper ion exchange.

### Electrochemical Measurements

Electrochemical measurements were carried out in lab-customized electrolysis setup. KOH (85%) pellets were purchased from Sigma Aldrich and the electrolytes were prepared with Milli-Q water. Electrolyte was supplied to both anode and cathode with a rate of 10 mL/min using peristaltic pump. MEAs were placed in 5 cm² 1 channel, 7 serpentine Ti flow fields (Fuel Cell Technologies, USA) and sealed using polytetrafluoroethylene (PTFE) gaskets. Ti felt (Bekaert, Belgium) was used as anode porous transport layer (PTL). The thicknesses of PTFE gaskets were chosen to ensure 20% total compression of PTLs. The cell was assembled at a torque of 9 Nm. The AEMWE tests and EIS were performed using XP 4105 (Ivium, the Netherlands) equipped with 20 A booster. Polarization curves were recorded by galvanostatic measurements by holding at each current density for 2 min with cut-off potential of 2.1 V. The results are shown in FIGS. 4 and 5. In FIG. 5 the results are compared with a cell comprising commercial electrodes that is measured in the same way.

FIG. 6 shows the results from a stability test wherein the formed MEA was tested for 70 hours. As can be seen the MEA was stable for at least that time period.

### Example 2

AEMWE is a promising and potentially low-cost technology for producing green hydrogen, but a novel manufacturing technique with rational design of the electrodes is essential to improve the performance and stability. In this Example, the effect of electrode structure on activity and the stability of AEMWEs was investigated by fabricating MEAs. The decal transfer method with PGM-free catalyst was successfully used in AEMWEs. With this method, deposition of a compact CL on the membrane was achieved without damaging the CL neither the membrane. The MEAs were designed for AEMWE using 1 M KOH as the electrolyte and the ionomer content was optimized for both cathode and anode. In the anode, a low ionomer loading improved activity and ionic conductivity, however, a higher ionomer content was beneficial for the cathode. An ionomer with low IEC (1.4-1.7 meq/g) and Nafion™ ionomer greatly improved the stability.

### Materials & Methods

### MEA Preparation

The MEAs were manufactured with the decal transfer method: NiFe nanoparticles (US Research Nanomaterials, Inc, APS: 40 to 100 nm) and Raney™ Nickel (ACROS organics, particle size: 20-60 μm) were used as anode and cathode catalysts. AP1 HNN8 00 X ionomer (Ionomer™ innovations, US) was added to the ink formulation to obtain CLs with the desired ionomer weight fractions. Anode CLs were also manufactured with 5 wt % AP1-HNN5-00-X ionomer (Ionomer™ innovations) or 5 wt % Nafion™ 1100 W (Merck, dispersion). The ink was prepared in 8 mL HDPE bottles and stirred with zirconia beads overnight. The ink was coated on a temperature resistant foil with a doctor blade and the wet film thickness was adjusted to obtain the desired loading. Fumatech™ FAA-3-50 membranes were coated on one side or on both sides with 1 cm² CLs via hot-pressing. The substrate was cut in 1 cm² square with a cutting die and hot pressed on the membrane for 300 s at 140° C. The loadings were determined by subtracting the weight of the decals before and after hot-press. The so made MEAs were left in 1 M KOH for 36 h, refreshing the solution twice, to replace the counter ions with OH− ions.

### SEM Microscopy

Cross-sectional SEM (Hitachi S-4800) with an accelerating voltage of 10 KV in combination with EDS was performed on the MEAs before ion-exchange and after electrolysis. The MEA were prepared by cryo-fracturing in liquid nitrogen.

### Cell Assembly and Electrochemical Characterization

Titanium serpentine flow fields with a 5 cm² active area were used on both the cathode and anode sides. The MEAs were placed between two 1 cm² titanium GDLs. To optimize the anode CLs composition, and avoid influence of cathode catalysts, membranes coated on only the anode side were tested while nickel felts were used as GDLs and cathode electrodes. PTFE sealing gaskets were used to isolate the active area of the flow fields to 1 cm² and to ensure 20% compression of the GDLs. The cell was tightened with a torque of 9 Nm. The cell was heated with two cartridge heaters and the temperature was set at 60° C. with a PID controller. 1 M KOH was pumped (3 mL/min) to both anode and cathode after being pre-heated in two heat exchangers. The electrolyte was recirculated after allowing the gas to disengage in two reservoir tanks.

Each MEA was cycled between 1.5 V and 1.8 V (scan rate 50 mV/s) for 10 times to stabilize its performance prior to the polarization curves. The polarization curves were recorded with a cut-off voltage of 2.1 V holding the currents constant for 120 s at each current density and an averaged value of cell voltage was calculated during the last 30 s. EIS was performed at each current used for recording the polarization curve. To test the stability of the MEAs, the cell was operated for 200 h at 200 mA/cm² or until MEA failure. A polarization curve and EIS measurements were recorded after the stability test.

### Results

### Anode Ionomer Optimization

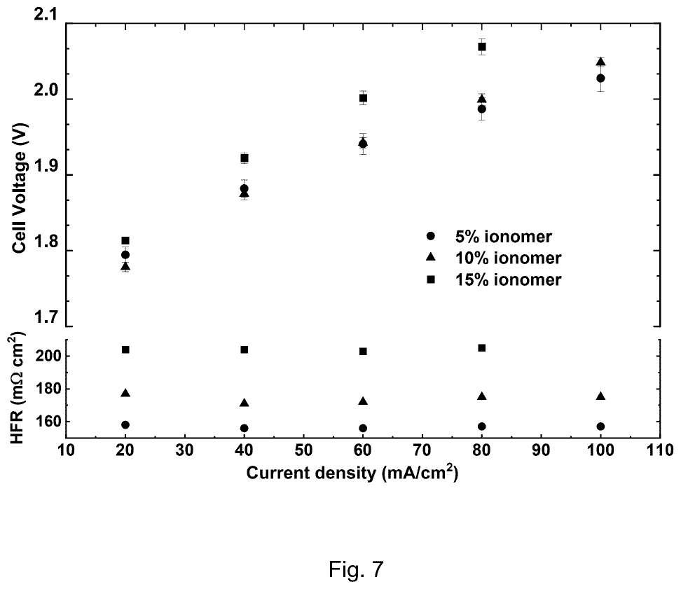

First, the influence of ionomer content on the anode electrode performance was studied. To do so, non-active components (titanium GDLs and flow fields) were chosen in the cell and the catalyst layers were well-separated from the GDLs by employing the CCM method. MEAs with CL only on the anode were manufactured in order to exclude cathode CL influence on the activity and reproducibility. For the HER, a Ni felt was used, acting as GDL and catalytic material. Weighing the decal before and after hot-pressing confirmed that the loading was 3 mg/cm² for all electrode compositions. Also, the CLs were not damaged during transfer and no appreciable quantity of catalyst was left on the substrate. FIG. 7 shows the polarization curves and the HFR for each current density, obtained with 5 wt %, 10 wt % and 15 wt % ionomer (AP1 HNN8-00-X) content. Decreasing the ionomer content from 15 wt % to 10 wt % strongly improved the anode electrode performance at all current densities. For example, a voltage drop of more than 60 mV was obtained at 80 mA/cm². For operation in 1 M KOH, further decreasing the ionomer content can be expected to improve the electrode performance. In fact, it can be noticed that performance further improved with 5 wt % ionomer content (FIG. 7). On the other hand, this improvement was limited by 5 wt % as the lower ionomer content is not sufficient for the adhesion of catalyst particles. Therefore, lower ionomer contents were not investigated. The HFR values followed the same trend. The resistance steadily decreased going from 15 wt % to 5 wt % ionomer content.

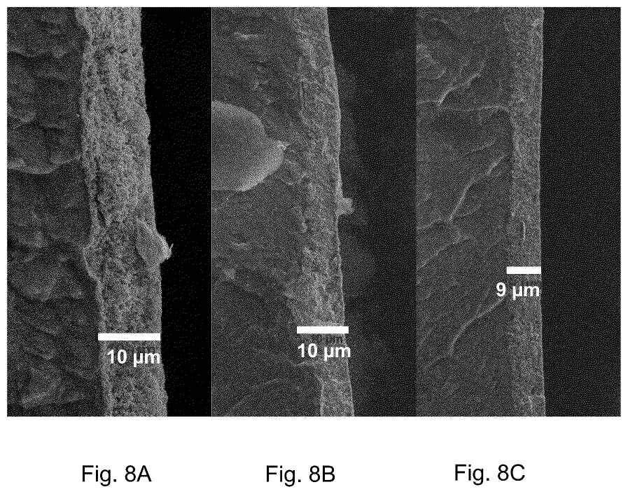

To understand the effect of ionomer content on the electrode structure, SEM microscopy was performed on the cross section of MEAs. FIGS. 8A-8C show cross-sections of the anode CLs with increasing ionomer content from 5 wt % to 15 wt %. A constant CL thickness around 9-10 μm was measured for the three samples. The anode CL is made up of spherical nanoparticles in the order of 100 nm (FIG. 8D). From BET, a specific surface of 3 m²/g was measured for the catalyst, which is in agreement with a theoretical average particle diameter of 220 nm assuming a density of 8900 kg/m³. Since the ionomer tends to segregate in the meniscus among catalyst nanoparticles, as it is seen in FIG. 8D, it was hard to detect a morphological difference between samples with different ionomer content. However, a quick calculation, indicates that the void volume fraction in CL increases as the ionomer content is reduced (Table 1). Also, the ionomer film, which coats the catalyst particle in the CL, is excepted to grow with increasing volume fraction of the ionomer. These parameters have shown to have a strong influence on the transport properties of the CL and agree with improved performance at low ionomer content. Furthermore, a reduced ionomer film thickness causes a lower contact resistance between the catalyst particles. If the CL resistance is assumed to be purely due to electrons percolations through catalyst particles at high frequency, as predicted by the transmission line model (Hartig-Weiß et al., “A Platinum Micro-Reference Electrode for Impedance Measurements in a PEM Water Electrolysis Cell” Journal of The Electrochemical Society 168(11): 114511 (2021)), this explains the reduced HFR at lower ionomer content. However, this may be not the cause since Ni and Fe oxides, which cover catalyst particles, are known to have low electronic conductivity. In fact, if the effective conductive of the electrolyte is higher than the electronic conductivity of the CL the electrolyte resistance will be part of the HFR not the CL electronic resistance. In the case of CLs with lower ionomer content these can take up more electrolyte and therefore have a lower ionic resistance.

TABLE 1
Comparison of the properties the anode CLs with
with 5 wt %, 10 wt %, 15 wt % ionomer content

| Ionomer | | | Electrode | Void Volume |
|---|---|---|---|---|
| content | Thickness | HFR^{a} | Resistance^{b} | Fraction^{c} |
| [%] | [μm] | [mΩcm²] | [mΩcm²] | [%] |
| 5 | 10 | 157 | 87 | 54 |
| 10 | 10 | 175 | 105 | 41 |
| 15 | 9 | 205 | 135 | 29 |

^{a}HFR values recorded at 80 mA/cm²
^{b}Calculated subtracting the resistance of the cell and GDLs (20 mΩcm²) and of the membrane (50 mΩcm²) from the HFR values
^{c}Calculated assuming the nickel density (8908 kg/m³) as the true density of the catalyst and the ionomer density being 1.2 g/cm³

### Cathode Ionomer Optimization

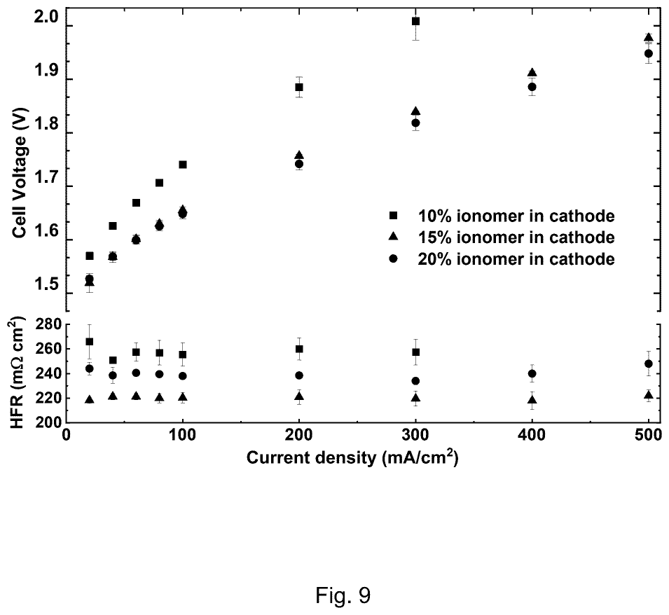

Introducing a Raney™ based cathode CL while keeping the anode CL with 5 wt % ionomer, improved the AEMWE performance significantly (FIG. 9). In fact, HER was reported as almost as limiting as OER in alkaline environment. Ionomer content for cathode CL was then optimized too. As for anode transfer, a loading of 12 mg/cm² was calculated and CL and membrane damages were not detected. Ti GDLs were used for both anode and cathode. In this case, ionomer content had a different effect on electrode performances (FIG. 9). The performances improved and the HFR decreased when the ionomer fraction was increased from 10 wt % to 15 wt % (FIG. 9). As discussed above, a higher ionomer loading was not expected to improve ion conduction or catalytic activity in the presence of 1 M KOH. Furthermore, increasing the ionomer content from 15 wt % to 20 wt % had a small effect on the MEA performance, while it increased the HFR. It should be mentioned that it was not possible to lower the ionomer content below 10 wt % due to the loss of mechanical integrity of the coating. In fact, compared to NiFe nanoparticles, Raney™ has a much higher specific surface area (˜100 m²/g) and required more binder.

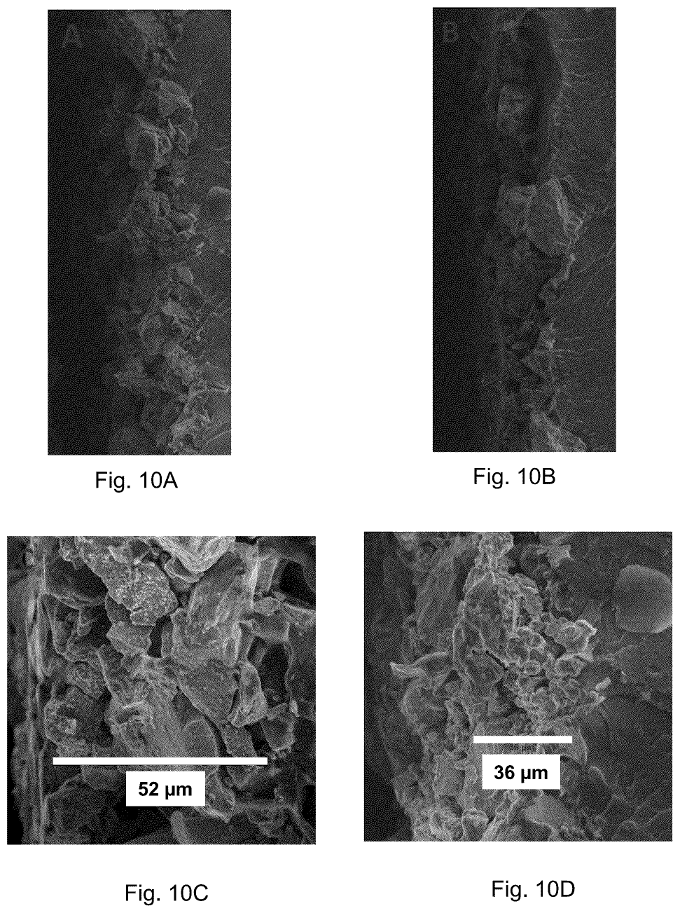

To understand this more complex effect of ionomer content on electrode performance, the cathode CL microstructure was investigated using SEM analysis. Large Raney™ particle are visible in FIGS. 10A-10D in the range of 10 μm, which impedes the deposition of a thinner catalyst layer. The internal pores of Raney™ (2-20 nm) are not visible since they fall below SEM resolution. Also, a slight indentation of the catalyst particles into the membrane is shown in FIGS. 10A-10D. This could affect the local hydrogen permeation and possibly induces membrane degradation. On the contrary, the anode CL is just deposited on the membrane (FIGS. 8A-8C) uniformly and without any indentation observed in the SEM images. Also, contrary to the anode, cathode CLs thickness varies with ionomer content (FIGS. 10A-10D). The cathode CL with 10 wt % ionomer is about 35 μm thick, while the CLs with 15 wt % and 20 wt % ionomer are about 50 μm thick. However, the catalyst loading was kept constant at 12 mg/cm². Even though the calculation of the void volume fraction is not straightforward, since it is difficult to estimate the true density of the Raney™ particles, a lower void fraction can be expected for the CL with 10 wt % ionomer due to its much lower thickness. Assuming the nickel density as the true density of the catalyst, a rough estimation shows that the CL resistance increases when the void volume decreases (Table 2). Also, a more compact and denser CL structure can be seen in FIG. 10C (10 wt %) than in FIG. 10D (20 wt %). The CL thickness is influenced by catalyst ink viscosity, so it is possible that the ink with the lower ionomer content allowed the catalyst to pack more closely, resulting in a lower void volume fraction and therefore, the electrolyte uptake was hindered. This reduces the positive effect that 1 M KOH has on anion transport and kinetics, and it explains why a poorer performance was obtained with the lowest ionomer concentration. Also, if the ionic conductivity is expected to prevail at high frequency, as discussed above, this explains why a higher HFR was obtained with the CL with lower ionomer content and lower void volume fraction. Furthermore, when the ionomer content is raised from 15 wt % to 20 wt %, the void volume fraction is expected to decrease again (CLs having the same thickness). As in the anode CLs, the HFR increased (FIG. 9) due to reduced electrolyte uptake and increased ionic resistivity of the CL. However, the negative effect on kinetics showed to be limited.

TABLE 2
Comparison of the properties the anode CLs with
10 wt %, 15 wt %, 20 wt % ionomer content

| Ionomer | | | Electrode | Void Volume |
|---|---|---|---|---|
| content | Thickness | HFR^{a} | Resistance^{b} | Fraction^{c} |
| [%] | [μm] | [mΩcm²] | [mΩcm²] | [%] |
| 10 | 36 | 256 | 99 | 29 |
| 15 | 52 | 220 | 63 | 45 |
| 20 | 52 | 238 | 81 | 36 |

^{a}HFR values recorded at 100 mA/cm²
^{b}Calculated subtracting the resistance of the cell and GDLs (20 mΩcm²) and of the membrane (50 mΩcm²) and of the anode catalyst layer (87 mΩcm² as in Table 1) from the HFR values
^{c}Calculated assuming the nickel density (8908 kg/m³) as the true density of the catalyst and the ionomer density being 1.2 g/cm³

### Optimization of Anode Ionomer Chemistry to Improve MEA Stability

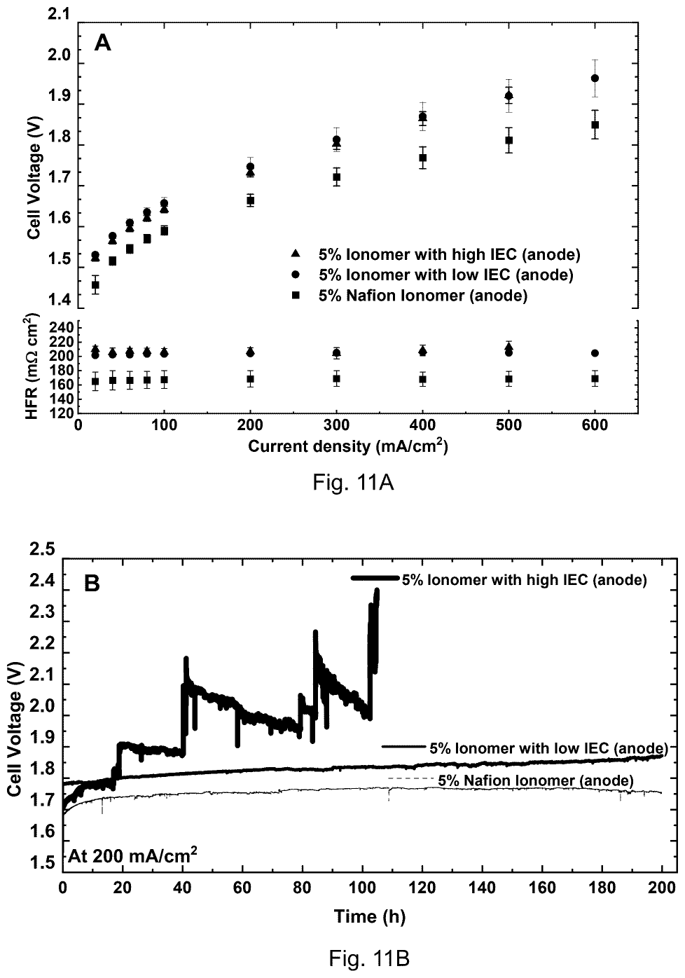

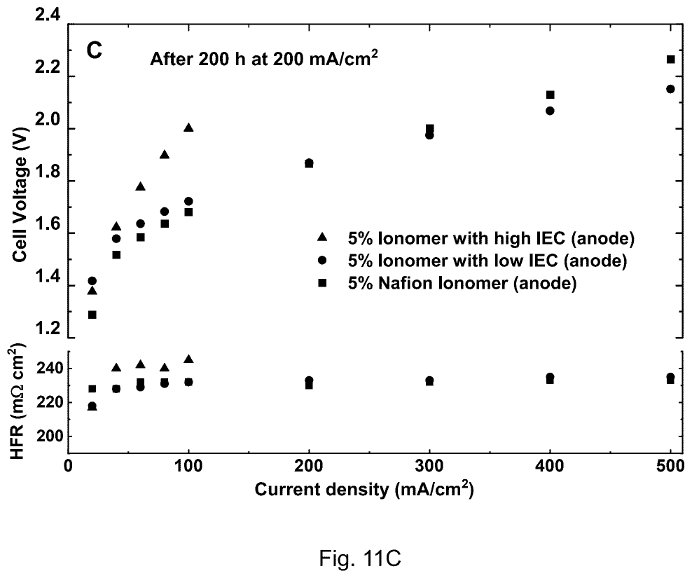

Since the ionomer in the anode CL has been already suspected as the decisive element for degradation in AEMWE, the effect of different ionomers on anode CL stability was studied. The ionomer (AP1 HNN8-00-X), used in the anode optimization of this Example and having a high IEC (2.1-2.5 meq/g), was replaced with an ionomer (AP1-HNN5-00-X) with same chemistry but a low IEC (1.4-1.7 meq/g) and with Nafion™, which has shown to be stable in AWE. A On the other side, a cathode with 20 wt % ionomer (AP1-HNN8-00-X) was used in these tests and 5 wt % was targeted for each ionomer/binder in the anode CL preparation. The MEAs with high and low IEC ionomers in anode CL showed similar initial performance (FIG. 11A). Even though the ionomer with low IEC is much less conductive, its conductivity had negligible effect on cell performance in 1 M KOH. On the other hand, the MEA with the Nation™ containing anode CL showed much higher performance and lower HFR. Both Nafion™ and the ionomer with low IEC highly improved the stability of MEAs (FIG. 11B). As a matter of fact, they both operated for 200 h at 200 mA/cm², and after an initial increase in cell voltage their performance stabilized. On the other hand, the MEA with high IEC ionomer failed after 100 hr after a series of abrupt increases in cell voltage. These results show the effect of IEC in ionomers on the stability of AEMWE. In fact, as other studies pointed out, the ionomers with high IEC have excessive water uptake, which causes their dissolution and loss of catalytic material. Also, at the end of the test, an increased HFR was measured (FIG. 11C), indicating a possible loss of conductivity of the membrane. To further investigate MEA degradation, SEM cross sections were analyzed before and at the end of the stability tests.

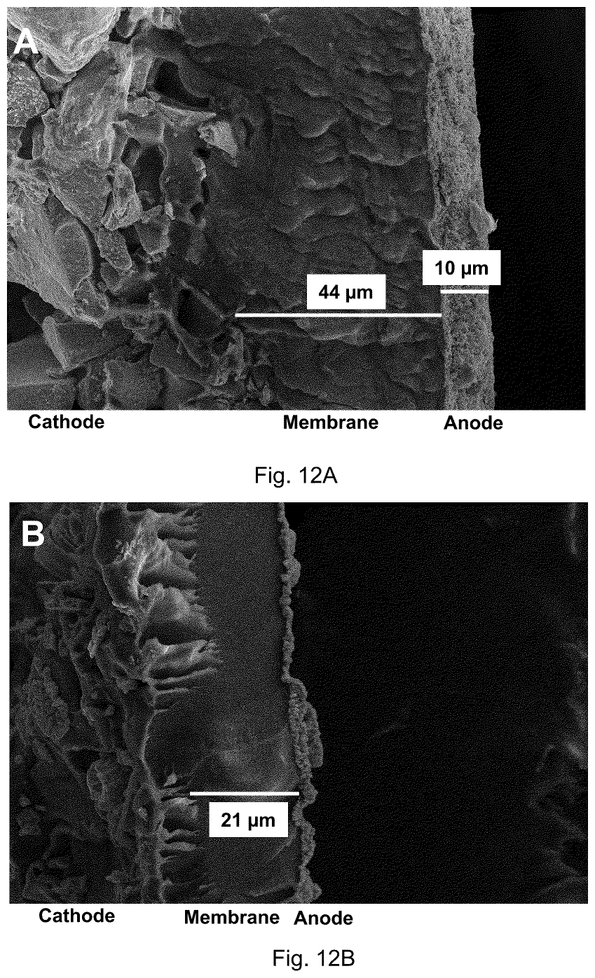

FIG. 12A shows the MEA with 5 wt % ionomer content in the anode and 20 wt % in the cathode after the hot-press. The thickness of the membrane was 45 μm, as reported by Fumatech™-damaging or thinning of the membrane was not detectable. Note that the hot-pressing was carried out below the degradation temperature (150° C.) of the membrane. FIG. 12B shows the cross-section of the MEA after 100 h of operation in 1 M KOH. Membrane thickness decreased to 20 μm due to the chemical degradation, such as polymer backbone cleavage in the alkaline environment. Indeed, aromatic ether bonds have been shown to react with hydroxides. Both CLs are severely damaged having lost active material. However, the cell disassembling might also have contributed to damage the CLs, making difficult to assess electrode degradation. KOH crystals were also found on the surface of the MEAs (FIG. 12B).

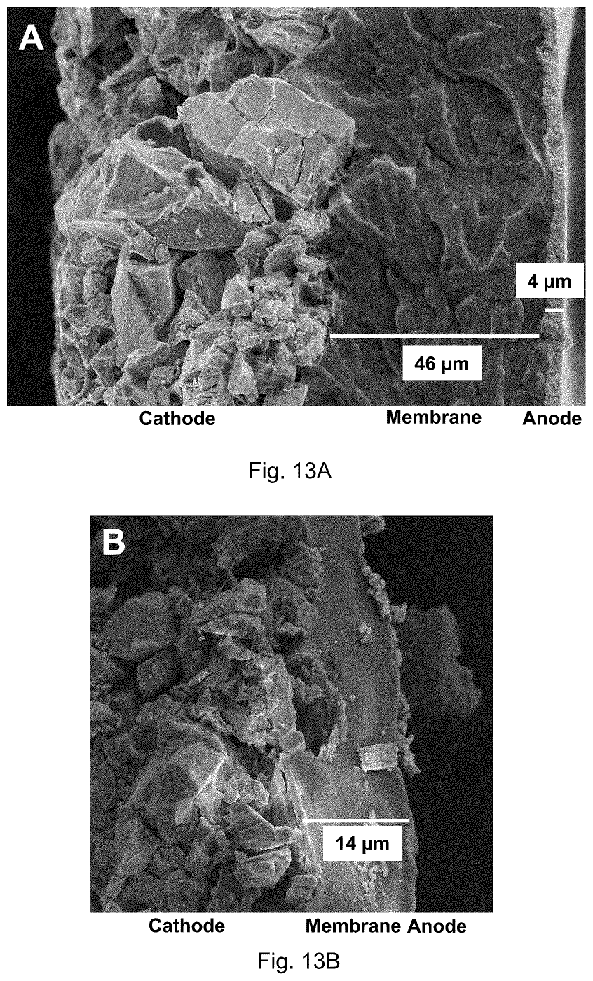

As the AP1-HNN8-00-X ionomer was replaced with Nafion™ (5 wt % content) in the anode CL the ink recipe was adjusted accordingly and water was introduced to the ink due to the Nation™ dispersion used in the ink preparation. It was found that the thickness of the electrode with Nafion™ was much lower (4 μm) than the one with AP1-HNN8-00-X (FIG. 13A) despite the same catalyst and binder loadings in the CL. Although the ink composition was slightly different, we attribute the difference in the final CL to the density of the binders. In fact, Nafion™ is almost two times denser than the AP1-HNN8-00-X ionomer (2 g/mL vs 1.2 g/mL). The lower electrode thickness explains why the HFR of the MEA was reduced by adding Nafion™ due to lower electrode resistance. Also, the performance could be improved by a lower binder volume fraction since anion exchange ionomers show particularly high volumetric swelling. SEM images of the MEA after 200 h (FIG. 13B) showed again that the membrane thickness reduced to 14 μm (FIG. 13B). Even though anode catalyst was almost completely removed from the MEA, it showed decent performance at the end of the test. So, some part of the catalyst was removed during cell disassembling.

In this Example, the decal transfer method was exploited to manufacture MEAs with PGM-free catalysts for AEMWE. The preparation technique showed the industrial potential of AEMWE and allowed more detailed characterization of the components of the MEAs. PGM free catalyst (NiFe for anode and Raney™ nickel for the cathode) were coated and transferred to the membrane without damaging either the CL either the membrane. The dimensions of the cathode catalyst particles are preferably reduced to decrease CL thickness and prevent damages of the membranes. Notably, the decal transfer method is a promising technique, which allows the deposition of such large particles on membrane. Furthermore, the MEAs could be cross-cut and post mortem morphological analysis could be made. The ionomer content had an influence on the performance of the MEAs. For the anode, a lower ionomer content CL showed better performance. In fact, an anion-exchange ionomer is less conductive than the liquid electrolyte, so a lower ionomer content allows a higher electrolyte uptake. On the cathode, however, a higher ionomer content improved the CL morphology resulting in higher activity and lower resistance. As the ink viscosity was increased, the CL deposition resulted in a more porous structure. The stability and the activity of the MEAs were highly improved by changing the ionomer chemistry in the anode CL. As a matter of fact, the ionomer IEC plays a role in MEA degradation. High IEC ionomer leads to excessive water uptake and dissolution, while the use of a low IEC ionomer allowed stable operation for 200 h. Also, the Nafion™ ionomer proved enough stable and greatly improved the MEA performance. Even though it does not provide ionic conductivity, it increased the anode performance because of lower electrode thickness and lower binder volumetric fraction.

### Example 3

This exampled compared characteristics of coated membranes for an anionic exchange membrane electrode assembly produced using fluorinated and non-fluorinated substrates and different solvents.

### Materials & Methods

The MEAs were manufactured with the decal transfer method: NiFe nanoparticles (US Research Nanomaterials, Inc) were used as anode catalysts. AP1-HNN8-00-X ionomer (Ionomer™ innovations, US) was added to the ink formulation to obtain CLs with the desired ionomer weight fractions. The solvent used for the ink was propanol, DMSO or DMSO containing 5 or 9 wt % water. The ink was prepared in 8 mL HDPE bottles and stirred with zirconia beads overnight. The ink was coated on PTFE, FEP or PET substrates with a doctor blade and the wet film thickness was adjusted to obtain the desired loading. PTFE, FEP or PET substrates were coated on one side with 1 cm² CLs via hot-pressing.

### Results

FIGS. 14A to 14D are photographs of coatings applied on PTFE membranes (FIGS. 14A, 14B) or PET membranes (FIGS. 14C, 14D) prior to or after drying using propanol as the solvent of the ink. Comparing the coatings applied on PTFE and PET membranes prior to drying clearly showing problems with coating contraction (marked with arrow) on the PTFE membrane (FIG. 14A) but no such contraction problems on the PET membrane (FIG. 14C). Correspondingly, following drying, the coating on the PTFE membrane cracked and peeled off the PTFE membrane (FIG. 14B) but the coating stayed attached on the PET membrane (FIG. 14D). However, the coating on the PET membrane had non-homogenous parts as indicated by the arrow in FIG. 14D.

FIGS. 15A to 15F are photographs of coatings applied on PTFE membranes (FIGS. 15A, 15B), PET membranes (FIGS. 15C, 15D) or FEP membranes (FIGS. 15E, 15F) prior to or after drying using DMSO as the solvent of the ink. Comparing the coatings applied on PTFE and FEP membranes and PET membranes prior to drying clearly showing problems with coating contraction (indicated by arrow) on the PTFE and FEP membrane (FIGS. 15A, 15E) but no such contraction problems on the PET membrane (FIG. 15C). Correspondingly, following drying, the coating on the PTFE and FEP membrane peeled off the PTFE and FEP membrane (FIGS. 15B, 15F) but the coating stayed attached on the PET membrane (FIG. 15D). The coating was more homogenous on the PET membrane using DMSO as solvent (FIG. 15D) as compared to using propanol as solvent (FIG. 14D).

FIGS. 16A to 16D are photographs of coatings applied on PET substrates prior to (FIGS. 16A, 16C) and after (FIGS. 16B, 16D) drying using DMSO containing 5 wt % (FIGS. 16A, 16B) or 9 wt % (FIGS. 16C, 16D) water. Comparing the coatings with different water content in the solvent prior to drying clearly showing problems with coating contraction (indicated by arrow) when the DMSO solvent contained 9 wt % water (FIG. 16A) but no such contraction problems were seen when using a lower content (5 wt %) in the DMSO solvent (FIG. 16C). Correspondingly, following drying, the coating based on the high water content solvent peeled off the PET membrane (FIG. 16B) but the coating with low water content stayed attached on the PET membrane (FIG. 16D).

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A process for producing a coated membrane for an anionic exchange membrane electrode assembly, comprising:
mixing a platinum group metal (PGM) free catalyst, an ionomer, and a solvent forming a solution;
coating a first non-fluorinated substrate with the solution forming a first coated non-fluorinated substrate;
drying the first coated non-fluorinated substrate allowing the solvent to evaporate forming a first dried coated non-fluorinated substrate;
applying the first dried coated non-fluorinated substrate to a first surface of a hydroxyl-free anion-exchange membrane forming a membrane substrate assembly, wherein the hydroxyl-free anion-exchange membrane comprises non-hydroxyl ions;
pressing the membrane substrate assembly using a hot-press forming a pressed membrane substrate assembly;
removing the first non-fluorinated substrate from the pressed membrane substrate assembly forming a coated membrane; and
exchanging the non-hydroxyl ions in the hydroxyl-free anionic exchange membrane for hydroxyl ions by soaking the coated membrane in a hydroxyl ion solution.

2. The process according to claim 1, wherein the first non-fluorinated substrate is selected from the group consisting of a polyethylene terephthalate (PET) substrate and a polyimide (PI) substrate.

3. (canceled)

4. The process according to claim 1,
wherein coating the first non-fluorinated substrate further comprises coating a second non-fluorinated substrate with the solution forming a second coated non-fluorinated substrate;
wherein drying the first coated non-fluorinated substrate further comprises drying the second coated non-fluorinated substrate allowing the solvent to evaporate forming a second dried coated non-fluorinated substrate; and
wherein applying the first dried coated non-fluorinated substrate further comprises applying the second coated non-fluorinated substrate to a second surface of the hydroxyl-free anion-exchange membrane, wherein the second surface of the hydroxyl-free anion-exchange membrane is opposite to the first surface.

5. The process according to claim 4, wherein pressing the membrane substrate assembly comprises hot pressing the membrane substrate assembly using the hot-press when the first dried coated non-fluorinated substrate has been applied to the first surface and the second dried coated non-fluorinated substrate has been applied to the second surface of the hydroxyl-free anion-exchange membrane.

6. The process according to claim 4, wherein the first and second non-fluorinated substrates are each selected from the group consisting of a polyethylene terephthalate (PET) substrate and a polyimide (PI) substrate.

7. (canceled)

8. The process according to claim 1, wherein the solvent is an anhydrous solvent selected from the group consisting of N-methyl-2-pyrrolidone (NMP), dimethylformamide (DMF), dimethyl sulfoxide (DMSO), and a mixture thereof.

9. (canceled)

10. (canceled)

11. The process according to claim 1, wherein the non-hydroxyl ions are selected from the group consisting of Br⁻, I⁻ and Cl⁻.

12. The process according to claim 1, wherein coating the first non-fluorinated substrate comprises coating the first non-fluorinated substrate with the solution using a decal method forming the first coated non-fluorinated substrate.

13. The process according to claim 1, wherein the PGM-free catalyst is selected from the group consisting of Ni, Fe, Co, Al, Cr, Mo, Ti, Cu, and any combination thereof.

14. (canceled)

15. (canceled)

16. The process according to claim 13, wherein the PGM-free catalyst particles have an average diameter selected within a range of from 40 nm to 60 μm.

17. (canceled)

18. The process according to claim 1, wherein the ionomer is selected from the group consisting of a hexamethyl-p-terphenyl poly(benzimidazolium) and a sulfonated tetrafluoroethylene based fluoropolymer-copolymer.

19. The process according to claim 1, wherein the coated membrane comprises from 2 up 20 mg PGM-free catalyst per cm² on the first surface of the hydroxyl-free anion-exchange membrane.

20. The process according to claim 1, wherein at least 25 cm² of the first surface of the hydroxyl-free anion-exchange membrane comprises a coating comprising the PGM-free catalyst and the ionomer.

21. (canceled)

22. An anionic exchange membrane electrode assembly comprising two electrodes and the coated membrane obtainable by the process according to claim 1 sandwiched between the two electrodes.

23. The anionic exchange membrane electrode assembly according to claim 22, wherein the coated membrane comprises a catalyst-comprising coating comprising PGM-free catalyst particles.

24. The anionic exchange membrane electrode assembly according to claim 23, wherein the PGM-free catalyst particles have an average diameter selected within a range of from 40 nm to 60 μm.

25. A coated membrane for water electrolysis obtainable by the process according to claim 1.

26. The coated membrane according to claim 25, wherein the coated membrane comprises a catalyst-comprising coating comprising PGM-free catalyst particles.

27. The coated membrane according to claim 26, wherein the PGM-free catalyst particles have an average diameter selected within a range of from 40 nm to 60 μm.

28. A water electrolysis cell comprising the coated membrane according to claim 25.
